(19) United States
(12) Patent Application Publication
(10) Pub. No.: US 2007/0091849 A1
(43) Pub. Date: Apr. 26, 2007

(54) Method and apparatus to provide for a handover on a wireless network

(75) Inventors: Soo-hong Park, Yongin-si (KR); Young-keun Kim, Incheon Metropolitan - City (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/545,691

(22) Filed: Oct. 11, 2006

(30) Foreign Application Priority Data
Oct. 20, 2005 (KR) 2005-99230

(51) Int. Cl. H04Q 7/00

(52) U.S. Cl. 370/331

(57) ABSTRACT

A method of integrating handover technology at a data link layer level with handover technology at a network layer level, and an apparatus. The method includes sending a first management message, which requests that a handover at a data link layer level be performed, to a serving base station, receiving a second management message, which includes information on a predetermined number of recommended neighboring base stations, in response to the first management message from the serving base station, selecting one of the neighboring base stations as a target base station, sending a third management message to the serving base station, which requests that a connection between the mobile station and the serving base station be released after a period of waiting time, and performing a high-speed handover procedure at a network layer level between the mobile station and the serving base station during the period of waiting time.

### CROSS-REFERENCE TO RELATED APPLICATIONS

This application claims the benefit of Korean Application No. 2005-99230, filed Oct. 20, 2005, in the Korean Intellectual Property Office, the disclosure of which is incorporated herein by reference.

### BACKGROUND OF THE INVENTION

1. Field of the Invention

Aspects of the present invention relate to a wireless communication technology, and, more particularly, to a method of effectively integrating handover technology at a data link layer level based on the IEEE (Institute of Electrical and Electronics Engineers) 802.16e standard with high-speed handover technology at a network layer level based on the ITEF (International Engineering Task Force) Mobile IPv6 standard (hereinafter, referred to as a method of ‘complex handover’) and an apparatus using the method.

2. Description of the Related Art

The IEEE 802.16 standard is one of the broadband wireless communication standards for MANs (Metropolitan Area Networks) and was developed by the IEEE working group. The original IEEE 802.16 standard published in December 2001 specifies a fixed point-to-multipoint broadband wireless system operated in an authorized spectrum band of 10 to 66 GHz. However, the revised IEEE 802.16a, which was approved in January 2003, specifies expanded non-line-of-sight within a spectrum of 2 to 11 GHz so as to send data at a speed of 70 Mbps at a distance of up to 50 km. Since a multimedia application may theoretically be performed in a wireless range of up to 50 km using the IEEE 802.16 standard known as ‘WirelessMAN™’, the IEEE 802.16 standard has become a practical last-mile technology.

While the IEEE 802.11 standard published before the IEEE 802.16 standard proposed an alternative to the Ethernet LAN (Local Area Network), the IEEE 802.16 standard proposes an alternative to a wireless connection such that, in order to complement the Ethernet LAN, offices are connected through a T1 line and the Internet. The advanced revised IEEE 802.16e supports mobile devices such that the mobile devices may be wirelessly connected.

In April 2001, a group of wireless business companies including Intel, Nokia, and Proxim organized a support group, known as ‘WiMAX’, to promote and to authorize compatibility and interoperation between devices based on the IEEE 802.16 standard and to develop devices to be released in a real market.

The development of technologies based on the IEEE 802.16 standard has also made a WiBro (wireless broadband) service available. Here, in order to be effective, the WiBro service should not be disconnected even if a user moves within a broad area. However, in order to supply the necessary continuous service where, for example, the user moves to another network which has a different subnet than the originally used subnet, mobile IPs (Internet Protocol) should be integrated. Therefore, in order to guarantee high-speed mobility among a plurality of subnets, a high-speed handover function specified in the IPv4 and IPv6 standards needs to be integrated with a handover function according to the IEEE 802.16e standard.

FIG. 1 is a view showing a handover procedure according to the IEEE 802.16e standard. In order to perform a handover, an MS (mobile station) 10 sends an MOB_MSHO_REQ message to a serving BS (base station) 20 to which the MS 10 is currently connected (S1). Then, the serving BS 20 sends an MOB_BSHO-RSP message that includes information that is necessary to perform a handover, such as lists of available neighboring BSs, to the MS 10 in response to the MOB_MSHO_REQ message (S2). Next, when the MS 10 sends an MOB_HO-IND message to the serving BS 20 (S3), the serving BS 20 disconnects the communication with the MS 10 (S4). Thereafter, the MS 10 is connected to a target BS (base station) 30 so as to continue the communication (S5).

However, in order to perform communication using an existing IP even after the MS 10 having a mobile IP moves to the target BS 30, a handover at the network layer level, that is, a high-speed handover procedure (including IP message exchanging processes) that is supported by ITEF should be performed in addition to a performance of a handover at a data link layer, especially, a MAC layer level. However, according to the current IEEE 802.16e standard, sufficient time to perform a high-speed handover is not available even if the MS 10 receives the MOB_RSHO-RSP message from the serving BS 20 and is able to communicate with the serving BS 20 and the target BS 30 because the lack of sufficient time is due to the fact that, according to the current IEEE 802.16e standard, as soon as the MS 10 receives the MOB_BSHO-RSP message, the MS 10 should send the MOB_HO-IND message to the serving BS 20 without an additional period of waiting time.

Since the communication between the serving BS 20 and the MS 10 is disconnected after the MS 10 sends the MOB_HO-IND message to the serving BS 20, performing a high-speed handover is not possible.

### SUMMARY OF THE INVENTION

Aspects of the present invention provide a method and an apparatus capable of applying a high-speed handover function selected as a standard by IETF to a WiMAX environment. In the present invention, the above-described and/or other problems may be relatively simply solved by modifying a definition of a part of fields in the MOB_HO-IND message.

In order to achieve the above and/or other aspects, a handover method of a mobile station on a wireless network, comprising: sending a first management message, which requests that a handover at a data link layer level be performed, to a serving base station; receiving a second management message, which includes information on a predetermined number of recommended neighboring base stations, in response to the first management message, from the serving base station; selecting one of the neighboring base stations as a target base station; sending a third management message to the serving base station, which requests that a connection between the mobile station and the serving base station be released after a period of waiting time; and performing a high-speed handover procedure at a network layer level between the mobile station and the serving base station during the period of waiting time.

Further, according to another aspect of the invention, a handover support method for use with a base station on a wireless network, comprising: receiving a first management message, which requests that a handover at a data link layer level be performed, from a mobile station; sending a second management message, which includes information on a predetermined number of recommended neighboring base stations, to the serving base station in response to the first management message; receiving a third management message, which requests that a connection between the base station and the mobile station be released, from the mobile station after a period of waiting time; and performing a high-speed handover procedure at a network layer level between the serving base station and the mobile station during the period of waiting time.

Furthermore, according to another aspect of the invention, a mobile station to perform a handover on a wireless network, comprising: a first unit to send a first management message, which requests that a handover be performed at a data link layer level, to a serving base station; a second unit to receive a second management message, which includes information on a predetermined number of recommended neighboring base stations, from the serving base station in response to the first management message; a third unit to select one of the neighboring base stations as a target base station; a fourth unit to send to the serving base station a third management message, which requests that a connection between the serving base station and the mobile station be released, after a period of waiting time; and a fifth unit to perform a high-speed handover procedure at a network layer level between the mobile station and the serving base station during the period of waiting time.

Furthermore, according to another aspect of the invention, a base station to support a handover on a wireless network, comprising: a first unit to receive a first management message, which requests that a handover at a data link layer level be performed; a second unit to send a second management message, which includes information on a predetermined number of recommended neighboring base stations, to the serving base station in response to the first management message; a third unit to receive a third management message, which requests that a connection between the base station and the mobile station, from the mobile station after a predetermined period of waiting time; and a fourth unit to perform a high-speed handover procedure at a network layer level between the serving base station and the mobile station.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a view showing a handover procedure according to the IEEE 802.16e standard;

FIG. 2 is a view showing environment to which a complex handover method is applied according to an embodiment of the present invention;

FIG. 3 is a block diagram showing a configuration of an MS according to the embodiment of the present invention;

FIG. 4 is a view showing a general configuration of a control message;

FIG. 5 is a block diagram showing a configuration of a BS according to the embodiment of the present invention;

FIG. 6 is a view showing a complex handover procedure according to an embodiment of the present invention; and

FIG. 7 is a view showing a high-speed handover procedure for use with the BS configuration of FIG. 5.

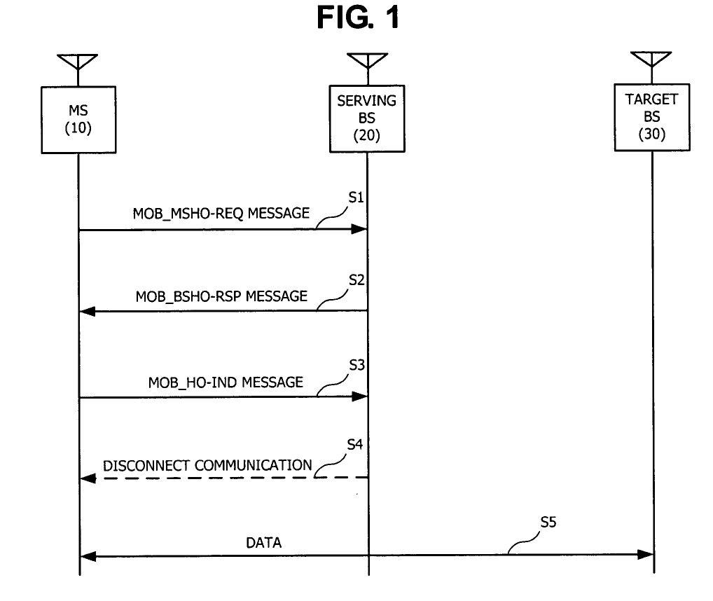

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

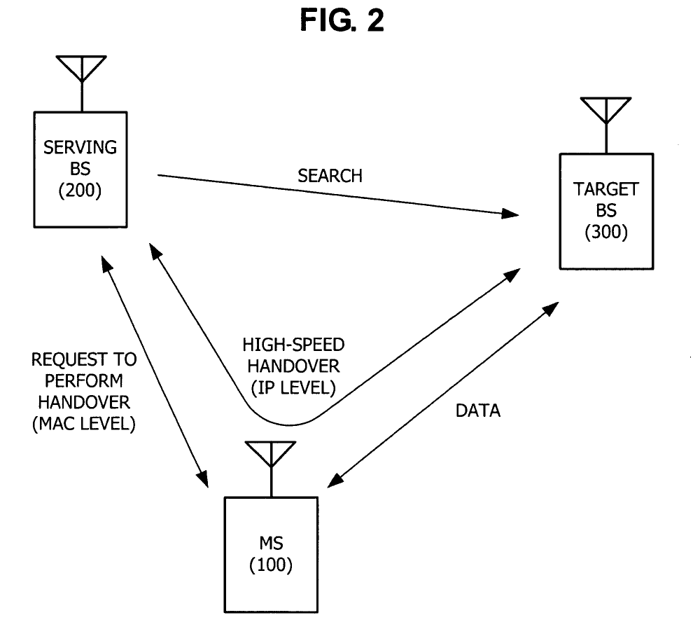

FIG. 2 is a view showing an environment to which a complex handover method according to an embodiment of the present invention is applied. An MS 100 is first connected to a serving BS 200 and then requests that the serving BS 200 perform a handover (at MAC layer level) when a performance of such a handover is necessary. Alternatively, the serving BS 200 may also request the MS 100 to perform the handover. In response to the request of the handover, the serving BS 200 searches neighboring BSs, prepares lists of BSs, and provides the lists to the MS 100. Then, the MS 100 selects and accesses a target BS 300 among the searched neighboring BSs and exchanges an IP message with the serving BS 200 and the target BS 300 so as to perform the high-speed handover. When the high-speed handover is completed, the serving BS 200 disconnects the communication, that is, releases the connection, with the MS 100. Then, the MS 100 may transmit/receive data to/from the target BS 300.

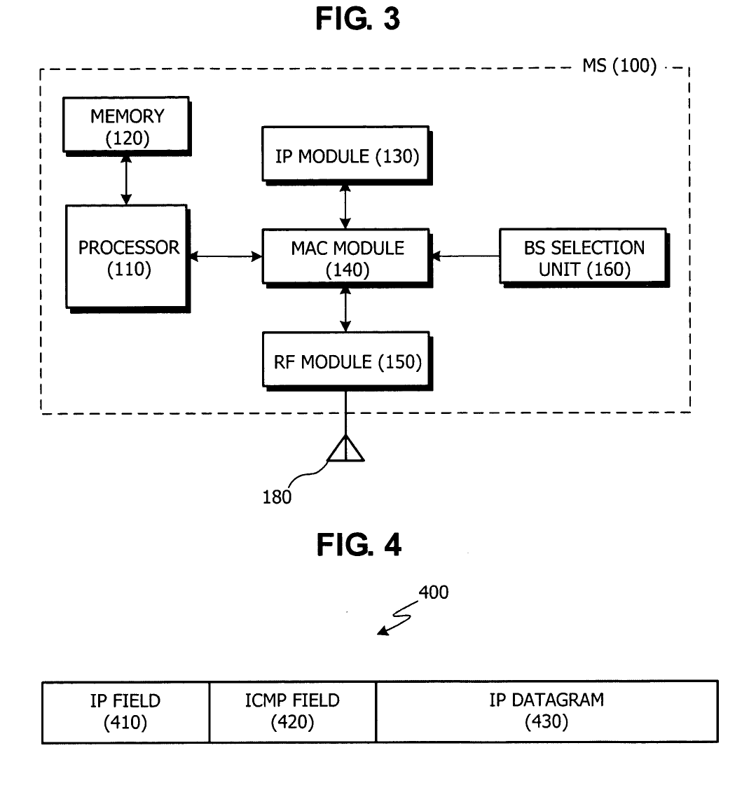

FIG. 3 is a block diagram showing a configuration of the MS 100 according to an embodiment of the present invention. The MS 100 includes a processor 110, a memory 120, an IP module 130, an MAC module 140, an RF module 150, and a BS selection unit 160. The processor 110 controls other components in the MS 100 and stores received data or data to be sent in the memory 120. The processor 110 may be implemented by a CPU (Central Processing Unit) or a Microprocessor. The memory 120 may be implemented by a RAM (Random Access Memory), a ROM (Read Only Memory), a flash memory, or other storage devices. The IP module 130 creates an IP message for performing high-speed handover. The IP message includes a control message, such as an RtSolPr (Router Solicitation for Proxy Advertisement) message or an FBU (Fast Binding Update) message, according to a mobile IPv6 standard. The RtSolPr message is a message that is used when the MS 100 requests information to allow for a performance of a handover to the serving BS 200 which currently functions as a router. The FBU message is a message that is used when the MS 100 commands the serving BS 200 to redirect traffic of the MS 100 toward the target BS 300 which functions as a new router.

FIG. 4 is a view showing a typical configuration of a control message 400 including the RtSolPr message and the FBU message. As shown in FIG. 4, the control message 400 includes an IP field 410, an ICMP (Internet Control Message Protocol) field 420, and an IP datagram 430. The IP datagram 430 is an actual payload and may be omitted in a case when there is no data to be sent. The IP field 410 generally includes a source address field, a destination address field, and a hop limit field (255 in a case of a control message). According to various embodiments of the invention, a configuration of the ICMP field 420 may be different depending on each of the control messages.

In the RtSolPr message, the ICMP field includes a type field, in which an experiment mobility protocol type is recorded, a code field in which ‘0’ is recorded, a checksum field in which an ICMPv6 checksum is recorded, a subtype field in which ‘2’ is recorded, a reserved field each of which ‘0’ is recorded and ignored by a user, and an identifier field. On the other hand, in the FBU message, the ICMP field includes a field each of which A, H, L, and K flags are recorded, a reserved field, a sequence number field, a lifetime field, and a mobility option field.

The MAC module 140 receives data (control message or general IP data) from the IP module 130, adds an MAC header to the received data, and then sends the data to the RF module 150. Further, the MAC module 140 creates and sends a management message of an MAC layer to the RF module 150 so as to perform handover according to the IEEE 802.16e standard.

The management message includes an MOB_MSHO-REQ message and an MOB_HO-IND message. When the MS 100 initializes a handover procedure, the MS 100 sends the MOB_MSHO-REQ message to the serving BS 200. The MOB_MSHO-REQ message may be sent based on a CID (Connection Identifier). The CID is an integer that is much smaller than a full address of a destination which is used to reduce an overhead of a packet header. According to the IEEE 802.16e standard, ‘57’ is recorded in the management message type field of the MOB_MSHO-REQ message.

Further, the MS 100 sends the MOB_HO-IND message to the serving BS 200 for a final indication immediately before performing the handover. The MS 100 may cancel or reject to the performance of the handover by a use of the MOB_HO-IND message. The MOB_HO-IND can also be sent based on the CID.

The MOB_HO-IND message includes a management message type field, a mode field, and a HO_IND_type field. According to the IEEE 802.16e standard, ‘59’ is recorded in the management message type field of the MOB_HO-IND message. In addition, four values, that is, 00 to 04, may be recorded in a two-bit mode field. In the case that ‘00’ is recorded in the mode field, the MS 100 requests to perform handover. In the case that ‘01’ is recorded in the mode field, the MS 100 requests that a soft handover be performed via a use of an anchor-BS-update. In the case that ‘10’ is recorded in the mode field, the MS 100 requests a performance of a soft handover by using an active-set-update. In the case that ‘11’ is recorded in the mode field, the MS 100 is reserved.

The two-bit HO_IND_type field is recorded only when the value of the mode field is ‘00’. According to the IEEE 802.16e standard, where a ‘00’ is recorded in the two-bit HO_IND_type field, the connection between the MS 100 and the serving BS 200 is released. Where a ‘01’ is recorded in the two-bit HO_IND_type field, the handover procedure is canceled. Where a ‘10’ is recorded in the two-bit HO_IND_type field, the handover procedure is rejected. Where an ‘11’ is recorded in the two-bit HO_IND_type field, MS 100 is reserved.

As is described above, if the serving BS 200 receives the MOB_HO-IND message, the serving BS 200 immediately releases the connection with the MS 100, it is not possible to perform the high-speed handover procedure at the IP layer. Accordingly, the present invention grants a new meaning to the reserved ‘11’ bit.

The HO_IND_type field according to the embodiment of the present invention may be defined as a table 1 below.

TABLE 1

| Bit | Definition |
|---|---|
| 00 | serving BS release |
| 01 | HO cancel |
| 10 | HO reject |
| 11 | serving BS release after WT |

According to table 1, when the HO_IND_type field includes a ‘00’, a ‘01’, or a ‘10’ bit, the handover procedure is performed according to the conventional IEEE 802.16e standard. However, when the HO_IND_type field includes an ‘11’ bit, the serving BS 200 releases the connection with the MS 100 after a predetermined period of time (waiting time, hereinafter, refer to as ‘WT’) such that the MS 100 obtains a period of time to perform the high-speed handover procedure.

The waiting time may be determined by a user of the MS 100 or a predetermined default value may be used as the waiting time. According to an embodiment of the invention, a value between approximately 1 and 2 seconds may be used as the waiting time. Further, after the MS 100 performs the high-speed handover, the MS 100 sends an additional informing message to the serving BS 200 to indicate that the waiting time is completed.

According to aspects of the present invention, if the HO_IND_type field has a ‘00’ bit, the serving BS 200 disconnects the communication with the MS 100 as soon as the serving BS 200 receives the MOB_HO-IND message. If the handover is not performed at the IP layer, disconnecting the communication immediately after receiving the MOB_HO-IND message is relatively simple. As is described above, where the handover is performed at the MAC level but is not performed at the IP layer, a subnet of the serving BS 200 to which the MS 100 is currently connected is the same as a subnet of the target BS 300. The reason for this is that, within the same subnet, the communication may be maintained normally even though the MS 100 uses an existing IP address after performing the handover at the MAC level.

The RF module 150 transmits RF (Radio Frequency) signals, which are created by modulating various MAC data, such as a management message created by the MAC module 140 or a data frame, by a predetermined modulation method (for example, BPSK, QPSK, 16-QAM, or 64-QAM), to the air through an antenna 180 and demodulates the RF signals received through the antenna 180 based on a predetermined demodulation method. The demodulated data is supplied to the MAC module 140 again.

The BS selection unit 160 reads an N_recommended field of the MOB_BSHO-RSP message in response to the MOB_MSHO-REQ message that is sent from the serving BS 200 and obtains ‘N’ recommended BS lists. A first list of the ‘N’ lists indicates a BS having the highest recommendation order and an N-th list of the ‘N’ lists indicates a BS having the lowest recommendation order. The BS selection unit 160 selects one of the BS lists, for example, the BS having the highest recommendation order, as the target BS.

Besides the N_recommended field, the MOB_BSHO-RSP message further includes a management message type field, a mode field, and a neighboring BS ID field. A ‘58’ may be recorded in the management message type field and eight bits from ‘000’ to ‘111’ may be recorded in the mode field. Here, ‘000’ means that the MS 100 requests that a handover is performed.

Then, the MAC module 140 determines whether the subnet of the target BS 300 that is selected by the BS selection unit 160 is the same as the subnet of the existing serving BS 200 using subnet information that is supplied from the IP module 130. As a result, when the subnet of the target BS 300 is the same as the subnet of the existing serving BS 200 (when high-speed handover procedure is not necessary), an MOB_HO-IND message in which the HO_IND_type field is set to ‘00’ is created. When the subnet of the target BS 300 different from the subnet of the existing serving BS 200 (when high-speed handover procedure is necessary), an MOB_HO-IND message in which the HO_IND_type field is set to ‘11’ is created. When the MS 100 does not try to perform handover at the MAC level, the handover request using the initial MOB_MSHO-REQ message may be cancelled (HO_IND_type field is set to ‘01’) or rejected (HO_IND_type field is set to ‘10’).

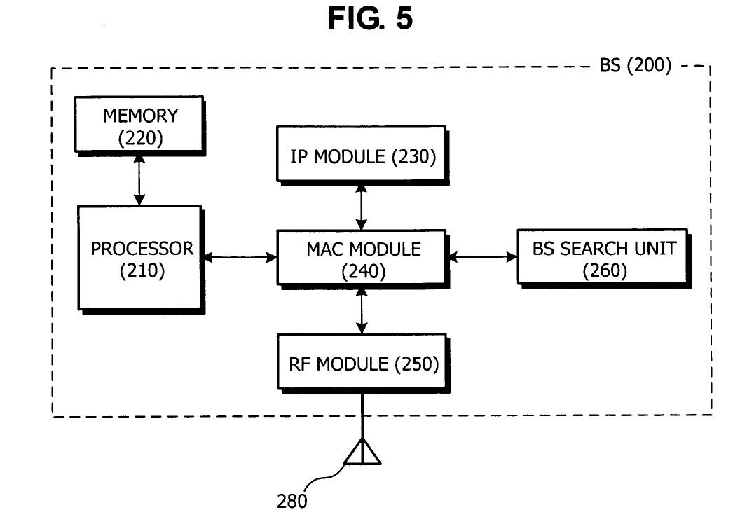

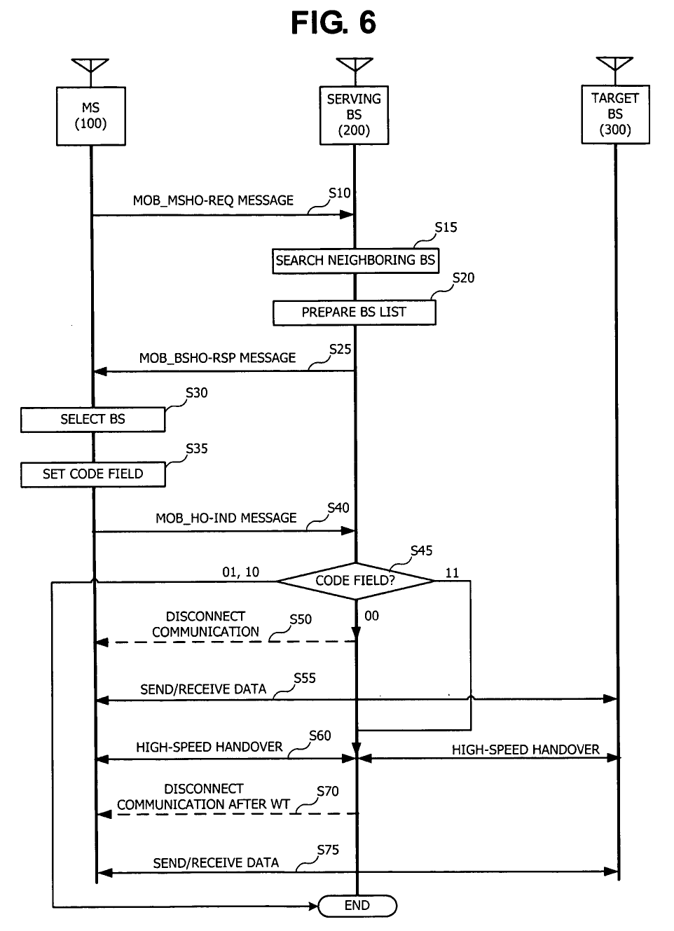

FIG. 5 is a block diagram showing a configuration of the BS 200 according to the embodiment of the present invention. As shown in FIG. 5, the BS 200 includes a processor 210, a memory 220, an IP module 230, an MAC module 240, an RF module 250, and a BS search unit 260. The BS 200 may function as the serving BS or the target BS. The processor 210 controls other components in the BS 200 and stores received data or data to be sent in the memory 220. The IP module 230 creates an IP message so as to perform high-speed handover. The IP message includes a control message such as a PrRtAdv (Proxy Router Advertisement) message, an HI (Handover Initiate) message, a Hack (Handover Acknowledgement) message, and an FBack (Fast Binding Acknowledgement) message according to a mobile IPv6 standard. The control message has a configuration as shown in FIG. 4.

The PrRtAdv message is a message that the BS 200 sends to the MS 100 in response to the RtSolPr message after the BS 200 having an access router function receives the RtSolPr message from the MS 100. The PrRtAdv message supplies a link-layer address (for example, MAC address), an IP address, and subnet prefixes of other neighboring BSs.

In the PrRtAdv message, the ICMP field includes a type field in which an experiment mobility protocol type is recorded, a code field, in which ‘0’, ‘1’, ‘2’, ‘3’, or ‘4’ is recorded, a checksum field, in which the ICMPv6 checksum is recorded, a subtype field, in which ‘3’ is recorded, a reserved field, in which ‘0’ is recorded and ignored by a receiver, an identifier field, and other options fields.

Where the Code field has a ‘0’ therein, the MS 100 should use an AP-ID (Access Point Identifier) tuple or an AR-info (Access Router information) tuple so as to perform movement detection or NCoA (New Care of Address) formulation. The AP-ID tuple is an identifier of an access point. The AR-info tuple refers to information such as an IP address or a prefix of a router. Where the code field has a ‘1’ therein, the PrRtAdv message is sent without solicitation. Where the code field has a ‘2’ therein, available router information does not exist. In addition, where the code field has a ‘3’ therein, new router information exists with respect to only a subnet of a requested access point.

The MS 100 is able to obtain information on a new router by reading the PrRtAdv message.

The HI message is a message that the serving BS 200, currently having an access router function, sends to another BS, that is, the target BS 300, having an access router function so as to initialize the handover procedure of the MS 100. In the HI message, the ICMP field includes a type field, in which an experiment mobility protocol type is recorded, a code field, in which 0 or 1 is recorded, a checksum field, in which the ICMPv6 checksum is recorded, a subtype field, in which a ‘4’ is recorded, an S-flag field, to which an allocated address is set, a U-flag field, which is a buffer flag, a reserved field each of which ‘0’ is recorded and ignored by a receiver, an identifier field, and other options fields.

When the former access router, that is, the serving BS, performs a high-speed binding update with respect to a PCoA (Previous Care of Address) using a source IP address, a ‘0’ is recorded in the code field. Further, when the former access router uses an address other than the PCoA as a source IP address, a ‘1’ is recorded in the code field.

A Hack (Handover Acknowledgment) message is an acknowledgement message with respect to the HI message. The code field included in the ICMP field has a ‘0’ to a ‘4’ or a ‘128’ to a ‘130’. When the code field has a ‘0’ therein, the message indicates that a request of the handover is accepted and that an NCoA (New Care of Address) is available. When the code field has a ‘1’ therein, the message indicates that a request of the handover is accepted but that the NCoA is not available. When the code field has a ‘2’ therein, the message indicates that a request of the handover is accepted but that the NCoA is already occupied. When the code field has a ‘3’ therein, the message indicates that a request of the handover is accepted but that the NCoA is allocated. When the code field has a ‘4’ therein, the message indicates that a request of the handover is accepted but that the NCoA is not allocated. When the code field has a ‘128’ therein, the message indicates that an error has occurred for an unknown reason. When the code field has a ‘129’ therein, the message indicates that the handover is prohibited by a manager. Finally, when the code field has a ‘130’ therein, the message indicates that the handover is not available because a system resource is not sufficient.

An FBack (Fast Binding Acknowledgement) message is an acknowledgement message with respect to the FBU message and is sent only when an A-flag of the FBU message is set. In a status field included in the ICMP field, a ‘0’ or a ‘1’, or a ‘128’ to a ‘131’ is recorded. When the status field has a ‘0’ recorded therein, the status field indicates that a request of a high-speed binding update is accepted. When the status field has a ‘1’ recorded therein, the status field indicates that a request of a high-speed binding update is accepted but that an NCoA (New Care of Address) is not available. When the status field has a ‘128’ to a ‘130’ recorded therein, the same definition as the code field of the Hack message may be applied. When the status field has a ‘131’ recorded therein, the status field indicates that the length of an interface identifier is not correct.

The BS search unit 260 shown in FIG. 5 searches available neighboring BSs and prepares lists of the searched ‘N’ BSs and information thereof. At this moment, the BS search unit 260 may determine a recommendation order of the searched BSs according to a predetermined reference and may prepare the lists based on the recommendation order.

The MAC module 240 receives data (control message or general IP data) from the IP module 230, adds a MAC header to the received data, and then sends the data to the RF module 250. Further, the MAC module 240 creates and sends a management message of the MAC layer to the RF module 250 so as to perform the handover according to the IEEE 802.16e standard.

The management message includes an MOB_BSHO-RSP message. The MOB_BSHO-RSP message is a management message that is sent in response to a sent MOB_MSHO-REQ message. The MOB_MSHO-REQ message includes an N_recommended field, a management message type field, a mode field, and a neighboring BS ID field. The ‘N’ BSs and information thereof searched by the BS search unit 260 may be recorded in the N_recommended field according to the recommendation order.

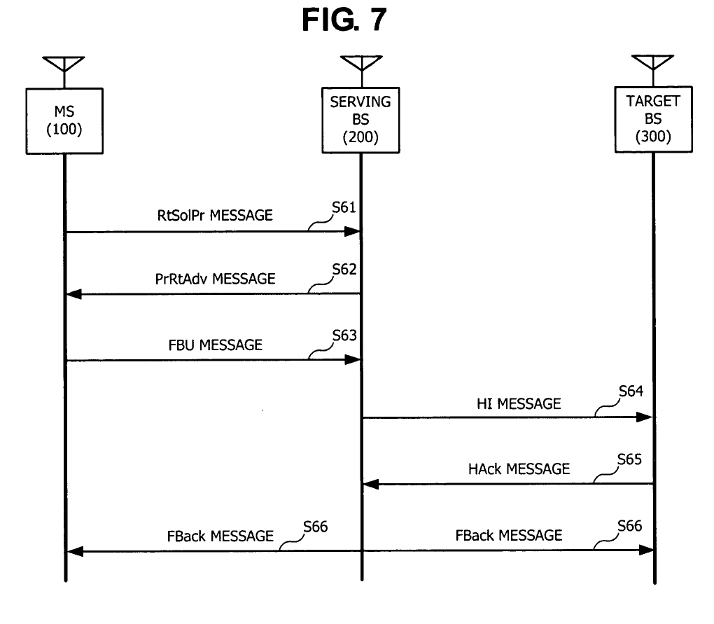

When a MOB_HO-IND message is received from the MS 100, the MAC module 240 reads the code field of the MOB_HO-IND message. When a value of the code field is read as ‘01’ (HO cancel) or as ‘10’ (HO reject), the MAC module 240 suspends the handover procedure. When a value of the code field is read as ‘00’, the MAC module 240 immediately disconnects the communication with the MS 100. When a value of the code field is read as ‘11’, the MAC module 240 disconnects the communication with the MS 100 after a period of waiting time. During the period of waiting time, a high-speed handoff procedure at the IP level is performed between the MS 100 and the serving BS 200 (refer to FIG. 7).

The RF module 250 sends RF (Radio Frequency) signals, which are created by modulating various MAC data, such as a management message created by the MAC module 240 or a data frame, by predetermined modulation methods (for example, BPSK, QPSK, 16-QAM, or 64-QAM) to the air through an antenna 280 and demodulates the RF signals received from the antenna 280 based on a predetermined demodulation method. The demodulated data is supplied to the MAC module 240 again.

The logic blocks described with reference to the embodiments of the invention shown in FIGS. 4 and 5 may be realized or performed using a general purpose processor designed to perform the functions described in this specification, a DSP (digital signal processor), an ASIC (application specific integrated circuit), an FPGA (field programmable gate array), another programmable logic unit, a discrete gate or a transistor logic unit, discrete hardware components, or a combination thereof. The general purpose processor may be a microprocessor. However, the general purpose processor may be, selectively, an arbitrary conventional processor, a controller, a microcontroller, or a state machine. Further, the general purpose processor may be realized by a combination of computing devices, for example, a combination of a DSP and a microprocessor, a plurality of microprocessors, and/or at least one microprocessor related to a DSP core, etc.

FIG. 6 is a view showing the complex handover procedure according to an embodiment of the present invention. As shown in FIG. 6, first, the MS 100 sends a MOB_MSHO-REQ message to the serving BS 200 so as to request a performance of a handover at a MAC layer level (S10). Then, the serving BS 200 searches available neighboring BSs using the BS search unit 260 in response to the MOB_MSHO-REQ message (S15). The serving BS 200 prepares lists corresponding to the ‘N’ BSs and information thereof obtained as a result of the search (S20). The serving BS 200 sends a MOB_BSHO-RSP message including the ‘N’ BSs and the information to the MS 100 (S25).

The MS 100 selects one of the ‘N’ BS lists recommended in the MOB_BSHO-RSP message as a target BS 300 (S30). The MS 100 determines whether to perform the handover and sets a code field of a MOB_HO-IND message (S35). When the MS 100 determines that the handover is not to be performed, the code field is set to a ‘01’ or a ‘10’. When the MS 100 determines that the handover is to be performed, whether the selected target BS 300 is included in the same subnet of the serving BS 200 is determined. When the selected target BS 300 is determined as being included in the same subnet of the serving BS 200, the code field is set to a ‘00’. Otherwise, the code field is set to ‘11’.

The MS 100 sends a MOB_BSHO-RSP message in which the code field is set to the serving BS 200 (S40). The serving BS 200 reads the code field (S45). If a read value is ‘01’ or ‘10’, the serving BS 200 terminates the handover and returns to the former process. Therefore, the MS 100 performs the communication through the serving BS 200.

If a read value is ‘00’, the serving BS 200 immediately disconnects the communication with the MS 100 (S50). Then, the MS 100 sends/receives data to/from the target BS 300 by using the existing IP address (S55). If, on the other hand, a read value is ‘11’, the serving BS 200 disconnects the communication with the MS 100 after a predetermined period of waiting time WT (S70). During the period of waiting time WT, the high-speed handover procedure is performed among the MS 100, the serving BS 200, and the target BS 300 (S60). After operation S70, since the high-speed handover procedure at the MAC level and the IP level is completed, the MS 100 sets the target BS 300 as a new BS such that the MS 100 sends/receives data to/from the target BS 300 (S75).

FIG. 7 is a view showing a high-speed handover procedure for use with the BS configuration of FIG. 5. Processes shown in FIG. 7 similar to the high-speed handover procedure suggested in the conventional mobile IPv6.

First, the MS 100 sends an RtSolPr message to the serving BS 200 so as to request that a handover be performed (S61). In response to the RtSolPr message, the serving BS 200 sends a PrRtAdv message to the MS 100 (S62). The RtSolPr message supplies a link-layer address, an IP address, and subnet prefixes of other neighboring BSs.

Next, the MS 100 sends an FBU message to the serving BS 200 so as to command the serving BS 200 to redirect traffic of the MS 100 toward the target BS 300 which functions as a new router (S63). The serving BS 200, which has received the FBU message, sends an HI message to the target BS 300 to initialize the handover procedure (S64). The target BS 300 which has received the HI message sends a Hack message to the serving BS 200, in response to the HI message (S65). The Hack message includes a code field that informs whether a request of the handover is accepted, whether the NCoA is available, and whether an error has occurred.

Finally, the serving BS 200 sends an FBack message which is an acknowledgement message with respect to the FBU message to the MS 100 and the target BS 300 (S66). As such, the high-speed handover procedure is completed. Thus, the MS 100 may communicate with the target BS 300 at the IP level.

Since operations S61, S62, and S63 correspond to a communication process between the MS 100 and the serving BS 200, operations S61, S62, and S63 may be performed before performing handover at the MAC level. Therefore, parts of or all of operations S61, S62, and S63 may be performed between operation S10 and operation S25 shown in FIG. 6.

According to aspects of the present invention, as is described above, the high-speed handover at the network layer level may be applied in the IEEE 802.16e standard environment. Therefore, a minimization of a loss of packets due to the change of an IP is possible even when a mobile station moves.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A handover method of a mobile station on a wireless network, comprising:
sending a first management message, which requests that a handover at a data link layer level be performed, to a serving base station;
receiving a second management message, which includes information on a predetermined number of recommended neighboring base stations, in response to the first management message, from the serving base station;
selecting one of the neighboring base stations as a target base station;
sending a third management message to the serving base station, which requests that a connection between the mobile station and the serving base station be released after a period of waiting time; and
performing a high-speed handover procedure at a network layer level between the mobile station and the serving base station during the period of waiting time.

2. The handover method of claim 1, wherein the first management message is a MOB_MSHO-REQ message based on the IEEE 802.16e standard.

3. The handover method of claim 1, wherein the second management message is a MOB_BSHO-RSP message based on the IEEE 802.16e standard.

4. The handover method of claim 1, wherein the third management message is a MOB_HO-IND message, and wherein, in a code field of the MOB_HO-IND message, a bit indicating that the connection is to be released after the period of waiting time, is recorded.

5. The handover method of claim 4, wherein the period of waiting time is determined based on a value designated by a user of the mobile station or a predetermined value between the mobile station and the serving base station.

6. The handover method of claim 1, wherein one of the recommended neighboring base stations having the highest recommendation order is selected as the target base station.

7. The handover method of claim 1, wherein the performing of the high-speed handover procedure at the network layer level comprises:
sending an RtSolPr message, which requests that the mobile base station performs the high-speed handover, to the serving base station;
sending a PrRtAdv message to the mobile station in response to the RtSolPr message from the serving base station;
sending an FBU message, which commands that traffic be redirected, to the serving base station from the mobile station;
sending an HI message, which instructs that the handover be initialized, to the target base station from the serving base station;
sending a Hack message to the serving base station in response to the HI message from the target base station; and
sending an FBack message to the mobile station and the target base station in response to the FBU message from the serving base station.

8. A handover support method for use with a serving base station on a wireless network, comprising:
receiving a first management message, which requests that a handover at a data link layer level be performed, from a mobile station;
sending a second management message, which includes information on a predetermined number of recommended neighboring base stations, to the serving base station in response to the first management message;
receiving a third management message, which requests that a connection between the serving base station and the mobile station be released, from the mobile station after a period of waiting time; and
performing a high-speed handover procedure at a network layer level between the serving base station and the mobile station during the period of waiting time.

9. The handover support method of claim 8, wherein the first management message is a MOB_MSHO-REQ message based on the IEEE 802.16e standard.

10. The handover support method of claim 8, wherein the second management message is a MOB_BSHO-RSP message based on the IEEE 802.16e standard.

11. The handover support method of claim 8, wherein the third management message is a MOB_HO-IND message, and wherein, in a code field of the MOB_HO-IND message, a bit indicating that the connection is to be released after the period of waiting time, is recorded.

12. The handover support method of claim 11, wherein the period of waiting time is determined based on a value designated by a user of the mobile station or a value predetermined between the mobile station and the serving base station.

13. The handover support method of claim 8, wherein the performing of the high-speed handover procedure at a network layer level comprises:
sending a RtSolPr message, which requests that the mobile base station performs the high-speed handover, to the serving base station;
sending a PrRtAdv message to the mobile station in response to the RtSolPr message from the serving base station;
sending an FBU message, which commands that traffic be redirected, to the serving base station from the mobile station;
sending an HI message, which instructs that the handover be initialized, to the target base station from the serving base station;
sending a Hack message to the serving base station in response to the HI message from the target base station; and
sending an FBack message to the mobile station and the target base station in response to the FBU message from the serving base station.

14. A mobile station to perform a handover on a wireless network, comprising:
a first unit to send a first management message, which requests that a handover be performed at a data link layer level, to a serving base station;
a second unit to receive a second management message, which includes information on a predetermined number of recommended neighboring base stations, from the serving base station in response to the first management message;
a third unit to select one of the neighboring base stations as a target base station;
a fourth unit to send to the serving base station a third management message, which requests that a connection between the serving base station and the mobile station be released, after a period of waiting time; and
a fifth unit to perform a high-speed handover procedure at a network layer level between the mobile station and the serving base station during the period of waiting time.

15. A base station to support a handover on a wireless network, comprising:
a first unit to receive a first management message, which requests that a handover at a data link layer level be performed;
a second unit to send a second management message, which includes information on a predetermined number of recommended neighboring base stations, to the serving base station in response to the first management message;
a third unit to receive a third management message, which requests that a connection between the base station and the mobile station, from the mobile station after a predetermined period of waiting time; and
a fourth unit to perform a high-speed handover procedure at a network layer level between the serving base station and the mobile station.

16. A handover method to be used in the operation of a mobile station on a wireless network, comprising:
requesting of a serving base station that a handover at a data link layer level be performed;
receiving information relating to recommended neighboring base stations from the serving base station;
selecting one of the neighboring base stations;
requesting of the serving base station that a connection between the mobile station and the serving base station be released after a period of waiting time; and
performing a high-speed handover procedure at a network layer level between the mobile station and the serving base station during the period of waiting time.

17. The handover method of claim 16, wherein the requesting of a serving base station that a handover at a data link layer level be performed comprises sending a MOB_MSHO-REQ message based on the IEEE 802.16e standard.

18. The handover method of claim 16, wherein the receiving of the information relating to the recommended neighboring base stations from the serving base station comprises receiving a MOB_BSHO-RSP message based on the IEEE 802.16e standard.

19. The handover method of claim 16, wherein the requesting of the serving base station that a connection between the mobile station and the serving base station be released after a period of waiting time comprises sending an MOB_HO-IND message, in which a bit indicating that the connection is to be released after the period of waiting time is recorded in a code field.

20. The handover method of claim 19, wherein the period of waiting time is determined based on a value designated by a user of the mobile station or is a predetermined value.

21. The handover method of claim 16, wherein the one of the recommended neighboring base stations having the highest recommendation order assigned thereto is selected as the target base station.

22. The handover method of claim 16, wherein the performing of the high-speed handover procedure at the network layer level comprises:
sending a request that the mobile base station perform the high-speed handover, to the serving base station;
sending a response to the request from the serving base station;
sending a command that traffic be redirected to the serving base station;
sending an instruction that the handover be initialized to the target base station;
sending a Hack message to the serving base station in response to the instruction; and
sending an FBack message to the mobile station and the target base station in response to the FBU message from the serving base station.

23. A handover method of a mobile station on a wireless network, comprising:
sending a MOB_MSHO-REQ message based on the IEEE 802.16e standard, which requests that a handover at a data link layer level be performed, to a serving base station;
receiving a MOB_BSHO-RSP message based on the IEEE 802.16e standard, which includes information on a predetermined number of recommended neighboring base stations, in response to the MOB_MSHO-REQ message, from the serving base station;
selecting one of the neighboring base stations as a target base station;
sending a MOB_HO-IND message to the serving base station, which requests that a connection between the mobile station and the serving base station be released after a period of waiting time; and
performing a high-speed handover procedure at a network layer level between the mobile station and the serving base station during the period of waiting time.
